(19) United States
(12) Patent Application Publication
(10) Pub. No.: US 2018/0246009 A1
(43) Pub. Date: Aug. 30, 2018

(54) Three Pins Axial Worm Inspection Device

(71) Applicant: Rong Luo, Jiangsu (CN)

(72) Inventors: RONG LUO, Suzhou City (CN); HUI LU, Suzhou City (CN); BAO WAN, Suzhou City (CN); SHENGTONG JING, Suzhou City (CN)

(21) Appl. No.: 15/118,442

(22) PCT Filed: Jul. 14, 2015
(86) PCT No.: PCT/CN2015/083937

§ 371 Date: Aug. 11, 2016

(30) Foreign Application Priority Data
May 15, 2015 (CN) 201510249207.7

(51) Int. Cl. G01M 13/02; G01B 11/24

(52) U.S. Cl. CPC G01M 13/021; G01B 11/2416

(57) ABSTRACT

A three pins axial worm inspection device which comprising a chassis, a mechanical hand, a axial worm inspection device, an uninspected axial worm carrying tray system, a first class axial worm carrying tray system, a second class axial worm carrying try system, a third class axial worm carrying tray mechanism and a fourth class axial worm carrying tray mechanism. The mechanical hand is arranged in the center of the inspection device, each class of axial worm carrying tray mechanism and axial worm inspection device are arranged around the mechanical hand for easy access; the input opening of the empty carrying tray and the output opening of the loaded carrying tray are arranged below and around the inspection device.

### FIELD OF THE INVENTION

Present invention relates to an inspection device for axial worm component in automobile steering wheel, more particularly, a three pins axial worm inspection device.

### BACKGROUND OF THE INVENTION

In the current technology, typically a three pins inspection device (adapting a three pins inspection or a three pins measurement) is used for inspecting the axial worm component in automobile steering wheel. The three pins inspection device commonly uses a tray to load a quantity of axial worms waiting for inspection, then a mechanical hand picks up each individual axial worm on the loading tray and transfer the axial worm to an inspection device (typically an optical sensing device), and after the axial worm is inspected the mechanical hand then place the inspected axial worm into different trays categorized by it's accuracy classes.

### SUMMARY OF THE INVENTION

The problems to be solve in the present invention: in a three pins inspection device to, how to arrange the loading trays of the uninspected axial worms, different trays of accuracy classes, the axial worm inspection device, and the mechanical hand for the layout of the three pins inspection device to be more rational and to increase utilization of the space.

The present invention offers the following solutions:

a three pins inspection device which comprising: a chassis, a mechanical hand, an axial worm inspection device, an input system of the uninspected axial worms, a first class axial worms carrying system, a second class axial worms carrying system, a third class axial worms carrying tray mechanism and a fourth class axial worms carrying tray mechanism;

the axial worm inspection device which comprising a first axial worm inspection device and a second axial worm inspection device;

the input system of the uninspected axial worms which comprising an input track of the uninspected axial worms, a carrying tray mechanism of the uninspected axial worms, and an empty carrying tray output track;

the first class axial worms carrying system which comprising a first class axial worms carrying tray mechanism, an empty carrying tray first input track, and a loaded tray first output track;

the second class axial worms carrying system which comprising a second class axial worms carrying tray mechanism, an empty carrying tray second input track, a loaded tray second output track;

the chassis is in a square box structure, the chassis which comprising a vertically arranged first side wall, a second wide wall, a third side wall, and a fourth side wall, the first side wall, the second wide wall, the third side wall, and the fourth side wall are surrounded to form a square, wherein, the first side is paralleled with the third side wall; the first side wall is provided with a uninspected axial worms input opening, the second side wall is provided with a loaded tray first output opening and a loaded tray second output opening, the third side wall is provided with a loaded tray third output opening and a loaded tray fourth output opening, and the fourth side wall is provided with an empty carrying tray output opening, an empty carrying tray first input opening, and an empty carrying tray second output opening;

the mechanical hand is arranged is the center of the square formed by the first, second, third, and fourth side wall;

the first axial worm inspection device is arranged to the inner side of the first side wall, and the second axial worm inspection device is arranged to the inner side of the fourth side wall;

the uninspected axial worm carrying tray mechanism is arranged to the inner side of the junction of the first and second side wall, the uninspected axial worms input track passes through the uninspected axial worms input opening to feed the uninspected axial worms carrying tray mechanism with trays loaded with uninspected axial worms, the empty carrying tray output track is located below the uninspected axial worms input track, the uninspected axial worms carrying tray mechanism which comprising a third lifting cylinders for driving the uninspected axial worms carrying tray mechanism to lift and lower, when the third lifting cylinders are extending, the uninspected axial worms carrying tray mechanism connects with the uninspected axial worms input track, when the lifting cylinders are in zero position, the uninspected axial worms carrying tray mechanism connects with the empty carrying tray output track, and the output end of the empty carrying tray output track passes through empty carrying tray output opening on the fourth side wall;

The first class axial worms carrying tray mechanism which is arranged to the inner side of the second side wall, the first class axial worms carrying tray mechanism is provided with a first lifting cylinders for driving the first class axial worms carrying tray mechanism to life and lower, when the first lifting cylinders are in zero position, the first class axial worms carrying tray mechanism connects with the first input track, the empty carrying tray first input track feeds the first class axial worm carrying tray mechanism with empty carrying trays, the input end of the empty carrying tray first input track is arranged at the empty carrying tray first input opening on the fourth side wall, when the first lifting cylinders are extending, the first class axial worm carrying tray mechanism connects with the loaded tray first output track, the loaded tray first output track outputs loaded trays on the first class axial worms carrying tray mechanism from the three pins inspection device, and the output end of the loaded tray first output track passes through the loaded tray first output opening on the second side wall;

the second class axial worm carrying tray mechanism which is arranged to the inner side of the second side wall, the second class axial worms carrying tray mechanism is provided with a second lifting cylinders for driving the second class axial worms carrying tray mechanism to life and lower, when the second lifting cylinders are in zero position, the second class axial worms carrying tray mechanism connects with the empty carrying tray second input track, the empty carrying tray second input track feeds the second class axial worm carrying tray mechanism with empty carrying trays, the input end of the empty carrying tray second input track is arranged at the empty carrying tray second input opening on the fourth side wall, when the second lifting cylinders are extending, the second class axial worm carrying tray mechanism connects with the loaded tray second output track, the loaded tray second output track outputs the loaded tray on the second class axial worms carrying tray mechanism from the three pins inspection device, and the output end of the loaded tray second output track passes through the loaded tray second output opening on the second side wall;

the first class axial worm carrying tray mechanism and the second class axial worm carrying tray mechanism are juxtapose placed; and the third class axial worm carrying tray mechanism and the fourth class axial worm carrying tray mechanism are arranged to the inner side of third side wall, the third class axial worm carrying tray mechanism and the fourth class axial worm carrying tray mechanism are arranged respectively close to the loaded tray third output opening and loaded tray output opening on the third side wall. The third class axial worm carrying tray mechanism and the fourth class axial worm carrying tray mechanism are juxtapose placed.

### BRIEF DESCRIPTION OF DRAWINGS

FIG. 1 is a structural view of the present invention three pins axial worm inspection device;

FIG. 2 is a top plane view of the inspection device in FIG. 1;

FIG. 3 is a bottom plane view of the inspection device in FIG. 1;

FIG. 4 is a left side view of the inspection device in FIG. 1;

FIG. 5 is a right side view of the inspection device from FIG. 4;

FIG. 6 is a right side view of the inspection device from FIG. 5;

FIG. 7 is a top plane of the uninspected axial worm carrying tray mechanism, first class axial worm carrying tray mechanism and second class axial worm carrying tray mechanism in FIG. 3;

FIG. 8 is top plane view of the roller carriage in the first class axial worm carrying tray mechanism in FIG. 7;

FIG. 9 is a right side view of the uninspected axial worm carrying tray mechanism from FIG. 7;

FIG. 10 is a bottom plane view of the FIG. 9;

FIG. 11 is a structural view of the first axial worm inspection device in FIG. 3; and

FIG. 12 is a structural view of the second axial worm inspection device in FIG. 3.

### DETAILED DESCRIPTION OF THE INVENTION

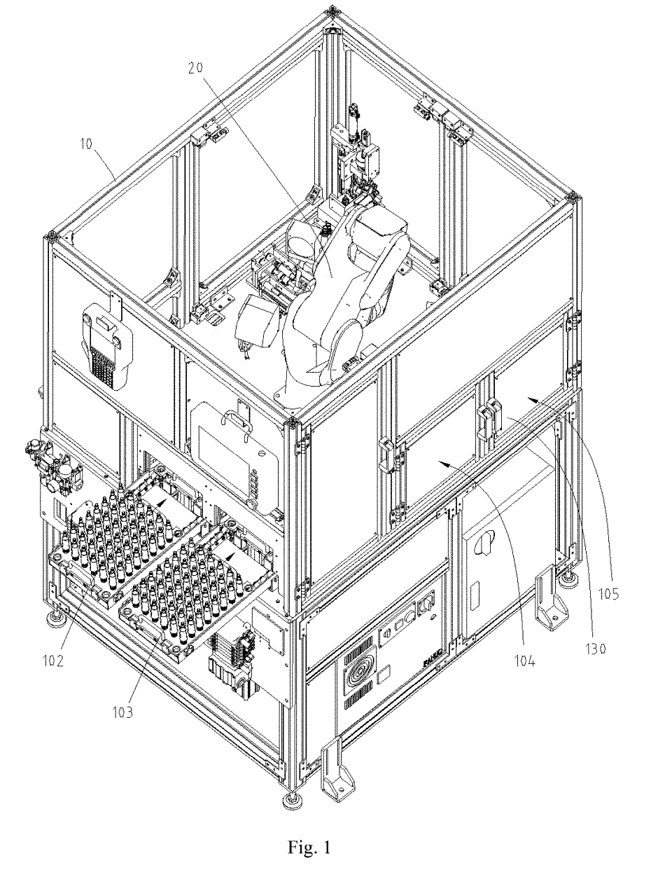

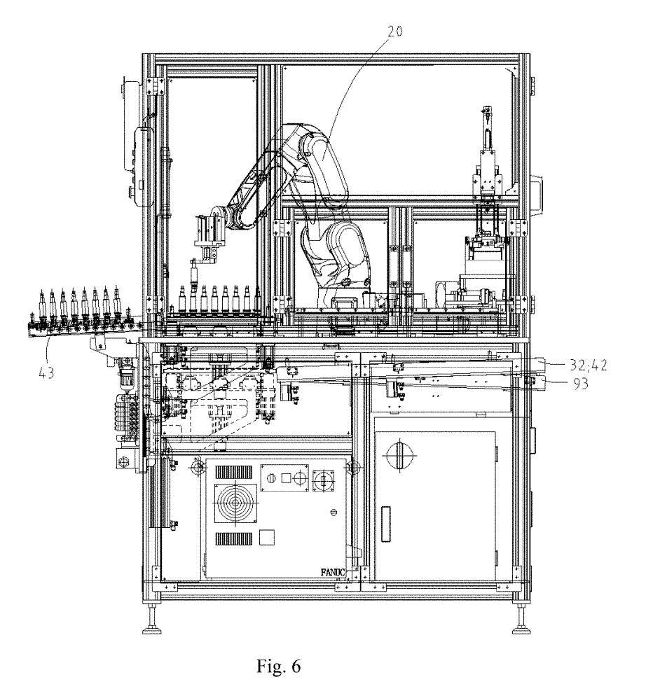

In combination of FIG. 1˜FIG. 6, a three pins inspection device which comprising: a chassis 10, a mechanical hand 20, an axial worm inspection device, an input system of the uninspected axial worms, a first class axial worms carrying system, a second class axial worms carrying system, a third class axial worms carrying tray mechanism 50 and a fourth class axial worms carrying tray mechanism 60. Wherein, the axial worm inspection device which comprising a first axial worm inspection device 70 and a second axial worm inspection device 80; wherein the input system of the uninspected axial worms which comprising an uninspected axial worms input track 91, an uninspected axial worms carrying tray mechanism 92, and an empty carrying tray carrying output track 93; the first class axial worms carrying system which comprising a first class axial worms carrying tray mechanism 31, an empty carrying tray first input track 32, and a loaded tray first output track 33; the second class axial worms carrying system which comprising a second class axial worms carrying tray mechanism 41, an empty carrying tray second input track 42, a loaded tray second output track 43.

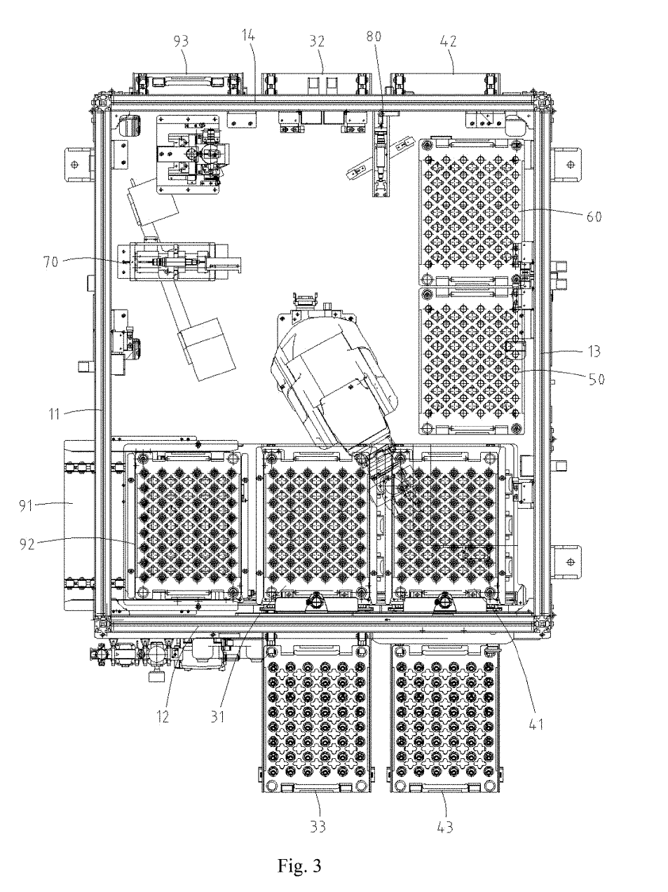

In combination of FIG. 1˜FIG. 3, the chassis 10 is in a square box structure, the chassis 10 which comprising a vertically arranged first side wall 11, a second wide wall 12, a third side wall 13, and a fourth side wall 14, the first side wall, the second wide wall, the third side wall, and the fourth side wall are surrounded to form a square, wherein, the first side is paralleled with the third side wall; the first side wall is provided with a uninspected axial worms input opening 101, the second side wall is provided with a loaded tray first output opening 102 and a loaded tray second output opening 103, the third side wall is provided with a loaded tray third output opening 104 and a loaded tray fourth output opening 105, and the fourth side wall is provided with an empty carrying tray output opening 106, an empty carrying tray first input opening 107, and an empty carrying tray second output opening 108.

In combination of FIG. 1 and FIG. 8, the mechanical hand 20 is arranged is the center of the square formed by the first, second, third, and fourth side wall.

As shown in FIG. 3, the first axial worm inspection device 70 is arranged to the inner side of the first side wall. As shown in FIG. 11, the first axial worm inspection device 70 which comprising a pair of sensing heads 71 and a axial worm self-turning device 72; the axial worm self-turning device which comprising a pair of juxtaposed turning rods 721 and a motor 722 for driving the pair of turning rods to rotate synchronously, the uninspected axial worms are placed on and in between the pair of turning rods 721; and the pair of sensing heads are placed to the two sides of the axial worm self-turning device.

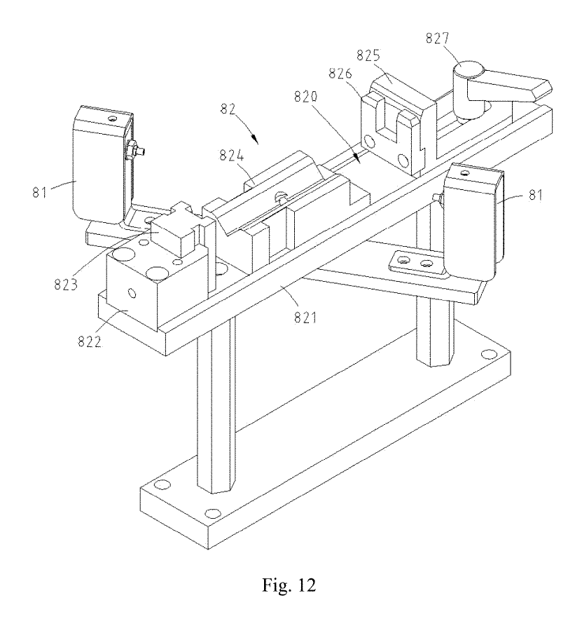

As shown in FIG. 3, the second axial worm inspection device 80 is arranged to the inner side of the fourth side wall. As shown in FIG. 12, the second axial worm inspection device 80 which comprising a pair of fiber optic sensors 81 and an axial worm resting device 82; the axial worm resting device which comprising a base panel 821, a fixing piece 822, a first positioning piece 823, a supporting piece 824, a sliding piece 825, a second fixing piece 826, and a threaded fixing member 827; the base panel is provided with sliding slot 820, the fixing piece is fixed in the sliding slot, the fixing piece is provided with slot, the first positioning piece snaps into the slot, the cross cut section of the supporting piece is in V shape, the supporting piece is fixed in the sliding slot, the supporting piece is used for supporting the uninspected axial worms, the sliding piece is provided with long sliding hole, the threaded fixing member passes through sliding hole then connects with the base panel, threaded fixing member fixes the sliding piece in the sliding slot, the second positioning piece is fixed on the sliding piece; the first positioning piece and the second positioning piece are arranged opposite to each other and to the two sides of the supporting piece; and the pair of fiber optic sensors are arranged to the two sides of the axial worm resting device.

As shown in FIG. 3, the uninspected axial worm carrying tray mechanism 92 is arranged to the inner side of the junction of the first and second side wall, the uninspected axial worms input track 91 passes through the uninspected axial worms input opening to feed the uninspected axial worms carrying tray mechanism with trays loaded with uninspected axial worms, the empty carrying tray output track 93 is located below the uninspected axial worms input track, the uninspected axial worms carrying tray mechanism which comprising a third lifting cylinders 921 for driving the uninspected axial worms carrying tray mechanism to lift and lower, when the third lifting cylinders are extending, the uninspected axial worms carrying tray mechanism connects with the uninspected axial worms input track, when the lifting cylinders are in zero position, the uninspected axial worms carrying tray mechanism connects with the empty carrying tray output track, and the output end of the empty carrying tray output track passes through empty carrying tray output opening on the fourth side wall.

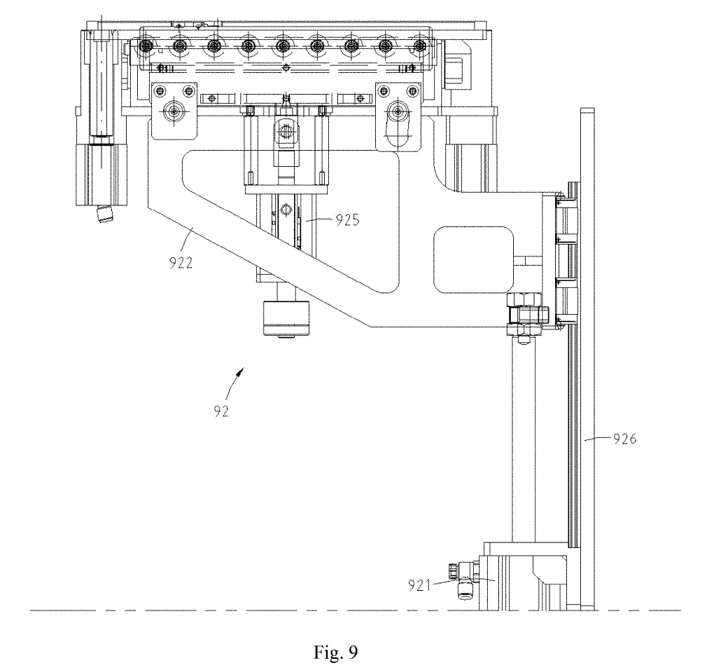

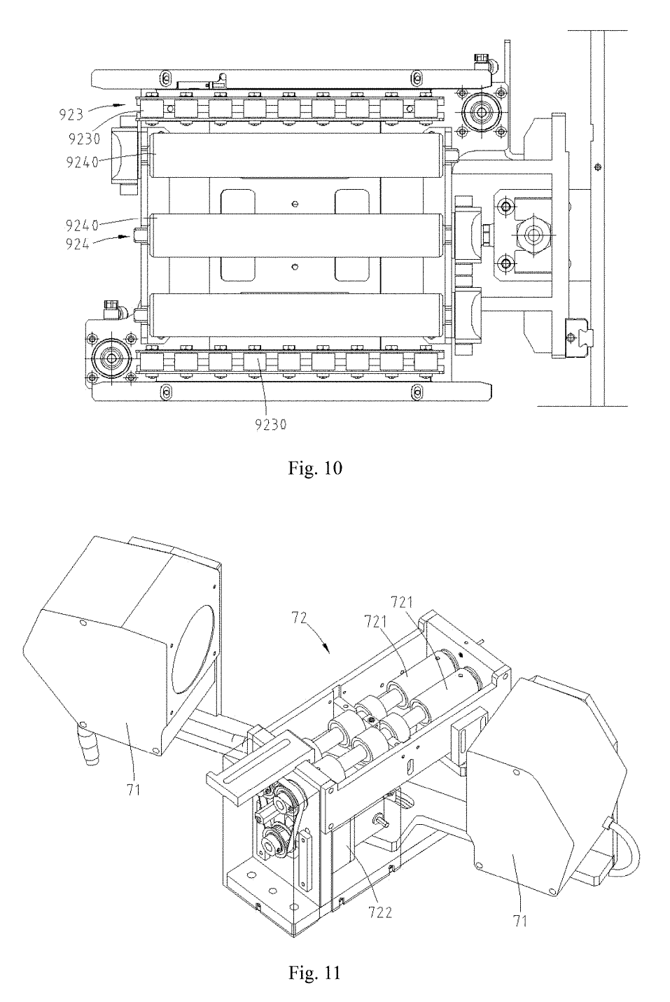

The above described uninspected axial worm carrying tray mechanism 92, in combination with FIG. 9 and FIG. 10, which comprising a chassis 922, a roller wheel carriage 923, a roller carriage 924 and an empty carrying tray discharging cylinder 925. The roller carriage is installed on the chassis 922, the roller carriage which comprising a set of leveled and juxtaposed electric roller 9240, the roller carriage which comprising an input end and an output end in relation to the feeding direction of the set of electric roller; the roller wheel carriage which comprising two rows of leveled and juxtaposed roller wheels 9230, the two rows of roller wheels are provided with an input end and an output end in relation to the feeding direction of the roller wheels; the roller wheel carriage and roller carriage are independent to each other, the feeding direction of the electrical roller is perpendicular to the feeding direction of the roller wheels, the two rows of roller wheels are arranged to the front of the input end and to the back of the output end respectively; the input end of the roller wheel carriage is hinged to the chassis, the empty carrying tray discharging cylinder is fixed on the chassis, the empty carrying tray discharging cylinder is arranged below the roller wheel carriage and the roller carriage, the free end of the piston rod of the empty carrying tray discharging cylinder is hinged to the center of the bottom of the roller wheel carriage, when the empty carrying tray discharging cylinder is in zero position, the roller wheel carriage is in leveled position and the top height of the two rows of the roller wheels is lower than the top height of the set of electrical roller, when the empty carrying tray discharging cylinder is in extending positioning, the roller wheel carriage turns in a certain degree of angle, the roller wheel carriage turns in a certain degree of angle where the top height of the two rows of the roller wheels is higher than the top height of the set of electric roller;

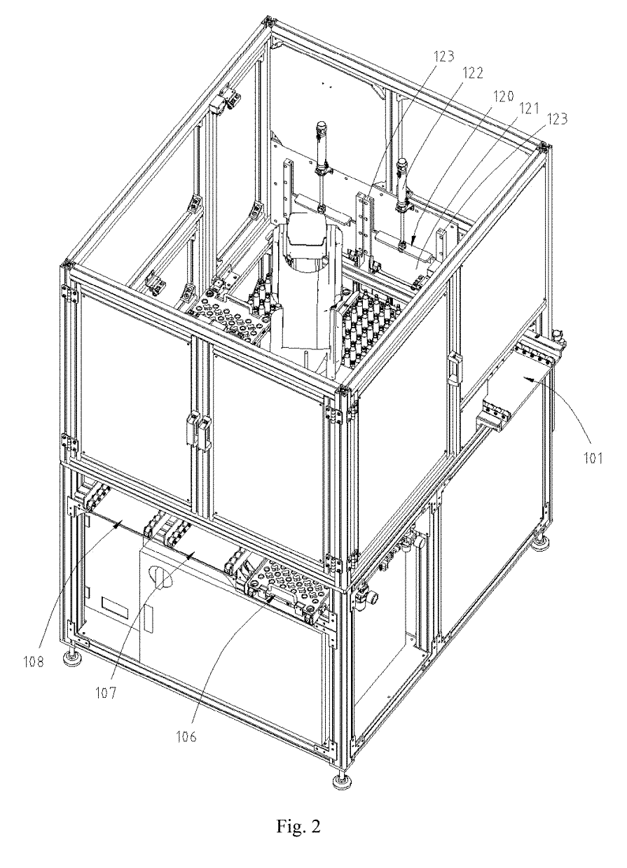

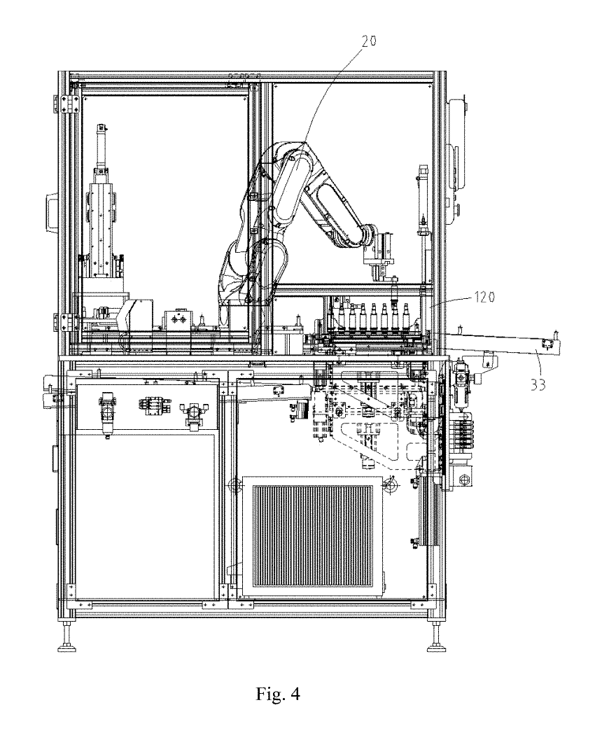

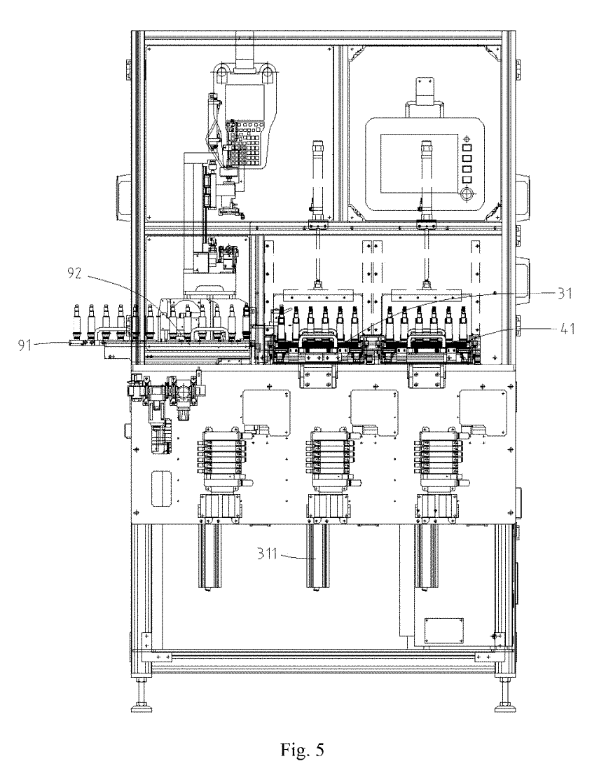

the above described uninspected axial worm carrying tray mechanism 92, in combination with FIG. 9 and FIG. 10, the uninspected axial worm carrying tray mechanism 92 which further comprising a vertically arranged supporting plate 926, the third lifting cylinder 921 is fixed onto the side wall of the supporting plate; the side wall of the supporting plate is provided with guide track, the chassis is provided with a sliding piece, the sliding piece couples with the guide track, the piston rod of the third lifting cylinder is vertically arranged and is fixed with the base of the chassis. In combination of FIG. 2, FIG. 3 and FIG. 4, when the third lifting cylinder is extending, the roller carriage in the uninspected axial worm carrying tray mechanism connects with the uninspected axial worm input track 91, when the lifting cylinder is in zero position, the turned certain degree angle roller wheel carriage in the uninspected axial worm carrying tray mechanism connects with empty carrying tray output track 93.

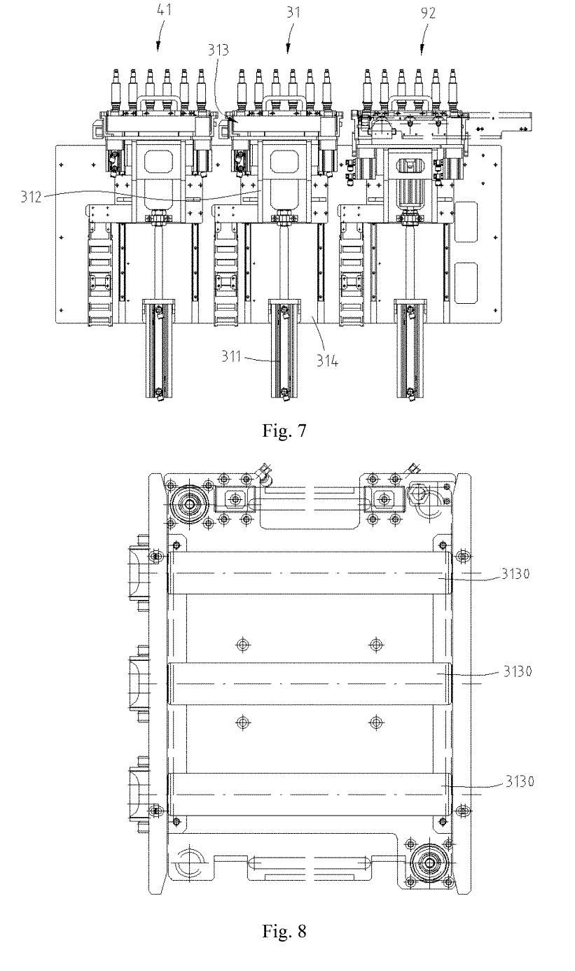

In combination of FIG. 3, FIG. 7 and FIG. 8, the first class axial worms carrying tray mechanism 31 which is arranged to the inner side of the second side wall, the first class axial worms carrying tray mechanism is provided with a first lifting cylinders 311 for driving the first class axial worms carrying tray mechanism to life and lower, when the first lifting cylinders are in zero position, the first class axial worms carrying tray mechanism connects with the empty carrying tray first input track 32, the empty carrying tray first input track feeds the first class axial worm carrying tray mechanism with empty carrying trays, the input end of the empty carrying tray first input track is arranged at the empty carrying tray first input opening on the fourth side wall, when the first lifting cylinders are extending, the first class axial worm carrying tray mechanism connects with the loaded tray first output track 33, the loaded tray first output track outputs the loaded tray on the first class axial worms carrying tray mechanism from the three pins inspection device, and the output end of the loaded tray first output track passes through the loaded tray first output opening on the second side wall.

The above described first class axial worm carrying tray mechanism 31, in combination of FIG. 3, FIG. 7 and FIG. 8, the first class axial worm carrying tray mechanism 31 which comprising a chassis 312 and a roller carriage 313 installed on the chassis 312, the roller carriage which comprising a set of leveled and juxtaposed electric roller 3130, the roller carriage which comprising an input end and an output end in relation to the feeding direction of the set of electric roller;

the above described first class axial worm carrying tray mechanism 31, in combination of FIG. 3, FIG. 7 and FIG. 8, the first class axial worm carrying tray mechanism 31 which further comprising a vertically arranged supporting plate 314, the first lifting cylinder 311 is fixed onto the side wall of the supporting plate; the side wall of the supporting plate is provided with guide track, the chassis is provided with a sliding piece, the sliding piece couples with the guide track, the piston rod of the third lifting cylinder is vertically arranged and is fixed with the base of the chassis. In combination of FIG. 2, FIG. 3, FIG. 4 and FIG. 6, when the first lifting cylinder is in zero position, the back end of the input end of the roller carriage in the first class axial worm carrying tray mechanism connects with the empty carrying tray first input track 32, and when the first lifting cylinder is extending, the front end of the input end of the roller carriage in the first class axial worm carrying tray mechanism connects with loaded tray first output track 33.

As shown in FIG. 3, the second class axial worm carrying tray mechanism 41 which is arranged to the inner side of the second side wall, the second class axial worms carrying tray mechanism is provided with a second lifting cylinders for driving the second class axial worms carrying tray mechanism to life and lower, when the second lifting cylinders are in zero position, the second class axial worms carrying tray mechanism connects with the empty carrying tray second input track 42, the empty carrying tray second input track feeds the second class axial worm carrying tray mechanism with empty carrying trays, the input end of the empty carrying tray second input track is arranged at the empty carrying tray second input opening on the fourth side wall, when the second lifting cylinders are extending, the second class axial worm carrying tray mechanism connects with the loaded tray second output track 43, the loaded tray second output track outputs the loaded tray on the second class axial worms carrying tray mechanism from the three pins inspection device, and the output end of the loaded tray second output track passes through the loaded tray second output opening on the second side wall.

Referring to the first class axial worm carrying tray mechanism 31, as shown in FIG. 7 and FIG. 8, the second class axial worm carrying tray mechanism which also comprising a chassis and a roller carriage installed on the chassis, the roller carriage which comprising a set of leveled and juxtaposed electric roller, the roller carriage which comprising an input end and an output end in relation to the feeding direction of the set of electric roller;

referring to first class axial worm carrying tray mechanism 31, as shown in FIG. 7 and FIG. 8, identically, the second class axial worm carrying tray mechanism which further comprising a vertically arranged supporting plate, the second lifting cylinder is fixed onto the side wall of the supporting plate; the side wall of the supporting plate is provided with guide track, the chassis is provided with a sliding piece, the sliding piece couples with the guide track, the piston rod of the second lifting cylinder is vertically arranged and is fixed with the base of the chassis; when the second lifting cylinder is in zero position, the back end of the input end of the roller carriage in the second class axial worm carrying tray mechanism connects with the empty carrying tray second input track 32, and when the second lifting cylinder is extending, the front end of the input end of the roller carriage in the second class axial worm carrying tray mechanism connects with loaded tray second output track.

As shown in FIG. 3 and FIG. 7, the above described uninspected axial worm carrying tray mechanism 92, the first class axial worm carrying tray mechanism 31 and the second class axial worm carrying tray mechanism 41 are juxtapose placed.

As shown in FIG. 1 and FIG. 3, the third class axial worm carrying tray mechanism 50 and the fourth class axial worm carrying tray mechanism 60 are arranged to the inner side of third side wall, the third class axial worm carrying tray mechanism and the fourth class axial worm carrying tray mechanism are arranged respectively close to the loaded tray third output opening and loaded tray output opening on the third side wall. The third class axial worm carrying tray mechanism and the fourth class axial worm carrying tray mechanism are juxtapose placed. The loaded tray third output opening 104 and the loaded tray fourth output opening 105 on the third side wall 13 are provided with a pair shutter door 130.

As shown in FIG. 2, the loaded tray first output opening 102 on the second side wall 12 is provided with a first safety door 120, the first safety door which comprising a door panel 121, a lifting cylinder 122 and a pair of guide tracks 123; the lifting cylinder is fixed onto the inner side of the second side wall, the piston rod of the lifting cylinder is fixed connected with the top side of the door panel, the pair of guide tracks are vertically arranged to the inner side of the second side wall, and the two sides of the door panel couple with the pair of guide track. Like the first safety door, the loaded tray second output opening 103 on the second side wall 12 is provided with a second safety door, the second safety door which comprising a door panel, a lifting cylinder and a pair of guide tracks; the lifting cylinder is fixed onto the inner side of the second side wall, the piston rod of the lifting cylinder is fixed connected with the top side of the door panel, the pair of guide tracks are vertically arranged to the inner side of the second side wall, and the two sides of the door panel couple with the pair of guide track.

The working principle of the present invention is mainly reflected in the two following aspects:

First, input of uninspected axial worms and output of empty carrying tray. A loaded axial worm carrying tray arrives at the uninspected axial worm inspection mechanism 92 by uninspected axial worm input track 91, the uninspected axial worm carrying tray mechanism 92 receives the loaded carrying tray; the mechanical hand 20 picks up axial worm from the loaded carrying tray and transport the axial worm to the axial worm inspection device, after the axial inspection device completes inspecting the axial worm, the mechanical hand places the inspected axial worm by it's accuracy class in the first class axial worm carrying tray 31, second class axial worm carrying tray 41, third class axial worm carrying tray 50 or fourth class axial worm carrying tray 60; when the loaded carrying tray becomes empty, the third lifting cylinder 921 drives the uninspected axial worm carrying tray mechanism 92 downward, once the uninspected axial worm carrying tray mechanism 92 connects with the empty carrying tray output track 93, the uninspected axial worm carrying tray mechanism 92 transfer the empty carrying tray onto the empty carrying tray track 93, then the empty carrying tray track transport the empty tray out of the three pin inspection device.

Second, input of empty carrying tray and output of inspected axial worm. Empty carrying tray arrives at the first class axial worm carrying tray mechanism 31 by the empty carrying tray first input track 32, the first class axial worm carrying tray mechanism 31 receives the empty tray, the first lifting cylinder 311 drives the first class axial worm carrying tray mechanism 31 upward to connect with the loaded carrying tray first output track 33; the empty carrying tray is transport to the second class axial worm carrying tray mechanism 41 by the empty carrying tray input track 42, the second class axial worm carrying tray mechanism 41 receives the empty tray, the second lifting cylinder drives the second class axial worm carrying tray mechanism upward to connect with the loaded carrying tray second output track 43; the empty carrying tray passes through the loaded carrying tray third output track 104 and the loaded carrying tray fourth output track 105 on the third side wall 13, and is placed on the third class axial worm carrying tray mechanism 50 and the fourth class axial worm carrying tray mechanism 60. When the carrying tray on the first class axial worm carrying tray mechanism 31 is fully loaded, the first class axial worm carrying tray mechanism 31 transfers the loaded carrying tray to the loaded carrying tray first output track 33, and the loaded carrying tray first output track 33 transports the loaded carrying tray out of three pin inspection device; when the carrying tray on the second class axial worm carrying tray mechanism 41 is fully loaded, the second class axial worm carrying tray mechanism 41 transfers the loaded carrying tray to loaded carrying tray second output track 43, and the loaded carrying tray second output track 43 transports the loaded carrying tray out of three pin inspection device; when the carrying tray on the third class axial worm carrying tray mechanism 50 and the fourth class axial worm carrying tray mechanism 60 is fully loaded, the operator removes the carrying tray from the loaded carrying tray third output opening 104 and the loaded carrying tray fourth output opening 105.

Although the invention has been explained in relation to its preferred embodiment, it is to be understood that many other possible modifications and variations can be made without departing from the spirit and scope of the invention as hereinafter claimed.

1. A three pin axial worm inspection device which comprising: a chassis, a mechanical hand, an axial worm inspection device, an input system of the uninspected axial worms, a first class axial worms carrying system, a second class axial worms carrying system, a third class axial worms carrying tray mechanism and a fourth class axial worms carrying tray mechanism; wherein, the axial worm inspection device which comprising a first axial worm inspection device and a second axial worm inspection device; wherein the input system of the uninspected axial worms which comprising an uninspected axial worms input track, an uninspected axial worms carrying tray mechanism, and an empty carrying tray carrying output track; the first class axial worms carrying system which comprising a first class axial worms carrying tray mechanism 31, an empty carrying tray first input track, and a loaded tray first output track; the second class axial worms carrying system which comprising a second class axial worms carrying tray mechanism, an empty carrying tray second input track, a loaded tray second output track;
wherein, the chassis is in a square box structure; wherein the chassis which comprising a vertically arranged first side wall, a second wide wall, a third side wall, and a fourth side wall, the first side wall, the second wide wall, the third side wall, and the fourth side wall are surrounded to form a square; wherein, the first side is paralleled with the third side wall; the first side wall is provided with a uninspected axial worms input opening, the second side wall is provided with a loaded tray first output opening and a loaded tray second output opening, the third side wall is provided with a loaded tray third output opening and a loaded tray fourth output opening, and the fourth side wall is provided with an empty carrying tray output opening, an empty carrying tray first input opening, and an empty carrying tray second output opening;
wherein, the mechanical hand is arranged is the center of the square formed by the first, second, third, and fourth side wall;
wherein, the first axial worm inspection device is arranged to the inner side of the first side wall;
wherein, the uninspected axial worm carrying tray mechanism is arranged to the inner side of the junction of the first and second side wall, the uninspected axial worms input track passes through the uninspected axial worms input opening to feed the uninspected axial worms carrying tray mechanism with trays loaded with uninspected axial worms, the empty carrying tray output track is located below the uninspected axial worms input track, the uninspected axial worms carrying tray mechanism which comprising a third lifting cylinders for driving the uninspected axial worms carrying tray mechanism to lift and lower, when the third lifting cylinders are extending, the uninspected axial worms carrying tray mechanism connects with the uninspected axial worms input track, when the lifting cylinders are in zero position, the uninspected axial worms carrying tray mechanism connects with the empty carrying tray output track, and the output end of the empty carrying tray output track passes through empty carrying tray output opening on the fourth side wall;
wherein, the first class axial worms carrying tray mechanism which is arranged to the inner side of the second side wall, the first class axial worms carrying tray mechanism is provided with a first lifting cylinders for driving the first class axial worms carrying tray mechanism to life and lower, when the first lifting cylinders are in zero position, the first class axial worms carrying tray mechanism connects with the empty carrying tray first input track, the empty carrying tray first input track feeds the first class axial worm carrying tray mechanism with empty carrying trays, the input end of the empty carrying tray first input track is arranged at the empty carrying tray first input opening on the fourth side wall, when the first lifting cylinders are extending, the first class axial worm carrying tray mechanism connects with the loaded tray first output track, the loaded tray first output track outputs the loaded tray on the first class axial worms carrying tray mechanism from the three pins inspection device, and the output end of the loaded tray first output track passes through the loaded tray first output opening on the second side wall;
wherein, the second class axial worm carrying tray mechanism which is arranged to the inner side of the second side wall, the second class axial worms carrying tray mechanism is provided with a second lifting cylinders for driving the second class axial worms carrying tray mechanism to life and lower, when the second lifting cylinders are in zero position, the second class axial worms carrying tray mechanism connects with the empty carrying tray second input track, the empty carrying tray second input track feeds the second class axial worm carrying tray mechanism with empty carrying trays, the input end of the empty carrying tray second input track is arranged at the empty carrying tray second input opening on the fourth side wall, when the second lifting cylinders are extending, the second class axial worm carrying tray mechanism connects with the loaded tray second output track, the loaded tray second output track outputs the loaded tray on the second class axial worms carrying tray mechanism from the three pins inspection device, and the output end of the loaded tray second output track passes through the loaded tray second output opening on the second side wall;
wherein, the uninspected axial worm carrying tray mechanism, the first class axial worm carrying tray mechanism and the second class axial worm carrying tray mechanism are juxtapose placed;
wherein, the third class axial worm carrying tray mechanism and the fourth class axial worm carrying tray mechanism are arranged to the inner side of third side wall, the third class axial worm carrying tray mechanism and the fourth class axial worm carrying tray mechanism are arranged respectively close to the loaded tray third output opening and loaded tray output opening on the third side wall; and
wherein, the third class axial worm carrying tray mechanism and the fourth class axial worm carrying tray mechanism are juxtapose placed.

2. The three pin axial worm inspection device as claimed in claim 1 wherein, the uninspected axial worm carrying tray mechanism which comprising a chassis, a roller wheel carriage, a roller carriage and an empty carrying tray discharging cylinder;
wherein, the roller carriage is installed on the chassis, the roller carriage which comprising a set of leveled and juxtaposed electric roller, the roller carriage which comprising an input end and an output end in relation to the feeding direction of the set of electric roller; wherein, the roller wheel carriage which comprising two rows of leveled and juxtaposed roller wheels, the two rows of roller wheels are provided with an input end and an output end in relation to the feeding direction of the roller wheels;
the roller wheel carriage and roller carriage are independent to each other, the feeding direction of the electrical roller is perpendicular to the feeding direction of the roller wheels, the two rows of roller wheels are arranged to the front of the input end and to the back of the output end respectively; wherein, the input end of the roller wheel carriage is hinged to the chassis, the empty carrying tray discharging cylinder is fixed on the chassis, the empty carrying tray discharging cylinder is arranged below the roller wheel carriage and the roller carriage, the free end of the piston rod of the empty carrying tray discharging cylinder is hinged to the center of the bottom of the roller wheel carriage, when the empty carrying tray discharging cylinder is in zero position, the roller wheel carriage is in leveled position and the top height of the two rows of the roller wheels is lower than the top height of the set of electrical roller, when the empty carrying tray discharging cylinder is in extending positioning, the roller wheel carriage turns in a certain degree of angle, the roller wheel carriage turns in a certain degree of angle where the top height of the two rows of the roller wheels is higher than the top height of the set of electric roller;
wherein, the uninspected axial worm carrying tray mechanism which further comprising a vertically arranged supporting plate, the third lifting cylinder is fixed onto the side wall of the supporting plate; wherein, the side wall of the supporting plate is provided with guide track, the chassis is provided with a sliding piece, the sliding piece couples with the guide track, the piston rod of the third lifting cylinder is vertically arranged and is fixed with the base of the chassis;
wherein, when the third lifting cylinder is extending, the roller carriage in the uninspected axial worm carrying tray mechanism connects with the uninspected axial worm input track, when the lifting cylinder is in zero position, the turned certain degree angle roller wheel carriage in the uninspected axial worm carrying tray mechanism connects with empty carrying tray output track.

3. The three pin axial worm inspection device as claimed in claim 1 wherein, the first class axial worm carrying tray mechanism which comprising a chassis and a roller carriage installed on the chassis, the roller carriage which comprising a set of leveled and juxtaposed electric roller, the roller carriage which comprising an input end and an output end in relation to the feeding direction of the set of electric roller;
wherein, the first class axial worm carrying tray mechanism which further comprising a vertically arranged supporting plate, the first lifting cylinder is fixed onto the side wall of the supporting plate; wherein, the side wall of the supporting plate is provided with guide track, the chassis is provided with a sliding piece, the sliding piece couples with the guide track, the piston rod of the third lifting cylinder is vertically arranged and is fixed with the base of the chassis;
wherein, when the first lifting cylinder is in zero position, the back end of the input end of the roller carriage in the first class axial worm carrying tray mechanism connects with the empty carrying tray first input track, and when the first lifting cylinder is extending, the front end of the input end of the roller carriage in the first class axial worm carrying tray mechanism connects with loaded tray first output track.

4. The three pin axial worm inspection device as claimed in claim 1 wherein, the loaded tray first output opening on the second side wall is provided with a first safety door, the first safety door which comprising a door panel, a lifting cylinder and a pair of guide tracks; the lifting cylinder is fixed onto the inner side of the second side wall, the piston rod of the lifting cylinder is fixed connected with the top side of the door panel, the pair of guide tracks are vertically arranged to the inner side of the second side wall, and the two sides of the door panel couple with the pair of guide track.

5. The three pin axial worm inspection device as claimed in claim 1 wherein, the second class axial worm carrying tray mechanism which comprising a chassis and a roller carriage installed on the chassis, the roller carriage which comprising a set of leveled and juxtaposed electric roller, the roller carriage which comprising an input end and an output end in relation to the feeding direction of the set of electric roller;
wherein, the second class axial worm carrying tray mechanism which further comprising a vertically arranged supporting plate, the second lifting cylinder is fixed onto the side wall of the supporting plate; the side wall of the supporting plate is provided with guide track, the chassis is provided with a sliding piece, the sliding piece couples with the guide track, the piston rod of the second lifting cylinder is vertically arranged and is fixed with the base of the chassis; when the second lifting cylinder is in zero position, the back end of the input end of the roller carriage in the second class axial worm carrying tray mechanism connects with the empty carrying tray second input track, and when the second lifting cylinder is extending, the front end of the input end of the roller carriage in the second class axial worm carrying tray mechanism connects with loaded tray second output track.

6. The three pin axial worm inspection device as claimed in claim 1 wherein, the loaded tray second output opening on the second side wall is provided with a second safety door, the second safety door which comprising a door panel, a lifting cylinder and a pair of guide tracks; the lifting cylinder is fixed onto the inner side of the second side wall, the piston rod of the lifting cylinder is fixed connected with the top side of the door panel, the pair of guide tracks are vertically arranged to the inner side of the second side wall, and the two sides of the door panel couple with the pair of guide track.

7. The three pin axial worm inspection device as claimed in claim 1 wherein, the loaded tray third output opening and the loaded tray fourth output opening on the third side wall are provided with a pair shutter door.

8. The three pin axial worm inspection device as claimed in claim 1 wherein, the first axial worm inspection device which comprising a pair of sensing heads and a axial worm self-turning device; wherein, the axial worm self-turning device which comprising a pair of juxtaposed turning rods and a motor for driving the pair of turning rods to rotate synchronously, wherein, the uninspected axial worms are placed on and in between the pair of turning rods; and the pair of sensing heads are placed to the two sides of the axial worm self-turning device.

9. The three pin axial worm inspection device as claimed in claim 1 wherein, the second axial worm inspection device which comprising a pair of fiber optic sensors 81 and an axial worm resting device; wherein, the axial worm resting device which comprising a base panel, a fixing piece, a first positioning piece, a supporting piece, a sliding piece, a second fixing piece, and a threaded fixing member; wherein, the base panel is provided with sliding slot, the fixing piece is fixed in the sliding slot, the fixing piece is provided with slot, the first positioning piece snaps into the slot, the cross cut section of the supporting piece is in V shape, the supporting piece is fixed in the sliding slot, the supporting piece is used for supporting the uninspected axial worms, the sliding piece is provided with long sliding hole, the threaded fixing member passes through sliding hole then connects with the base panel, threaded fixing member fixes the sliding piece in the sliding slot, the second positioning piece is fixed on the sliding piece; wherein, the first positioning piece and the second positioning piece are arranged opposite to each other and to the two sides of the supporting piece; and the pair of fiber optic sensors are arranged to the two sides of the axial worm resting device.
